(19) United States
(12) Patent Application Publication
(10) Pub. No.: US 2025/0233494 A1
(43) Pub. Date: Jul. 17, 2025

(54) METHOD FOR PRODUCING AT LEAST ONE LIQUID CHANNEL IN A LAMINATED CORE, AND LAMINATED CORE WITH SAID LIQUID CHANNEL

(71) Applicant: voestalpine Stahl GmbH, Linz (AT)

(72) Inventor: Ronald Fluch, Linz (AT)

(21) Appl. No.: 18/703,214

(22) PCT Filed: Oct. 21, 2022
(86) PCT No.: PCT/EP2022/079443

§ 371 Date: Apr. 19, 2024

(30) Foreign Application Priority Data
Oct. 21, 2021 (EP) 21204084.4

(51) Int. Cl. H02K 15/0273; B32B 3/26; B32B 7/12; B32B 15/01; H02K 1/20

(52) U.S. Cl. CPC H02K 15/0273; B32B 3/266; B32B 7/12; B32B 15/011; H02K 1/20; B32B 2307/208; B32B 2457/00

(57) ABSTRACT

A method for producing at least one liquid channel in a laminated core and a laminated core having this liquid channel are disclosed. In order to produce a media-tight liquid channel, it is proposed for a collar to be produced on each of at least two openings in that these collars are formed into the piece of sheet metal or sheet metal strip and/or sheet metal part, or at least two openings each having a collar are produced in the piece of sheet metal or sheet metal strip in that these collars are formed into the piece of sheet metal or sheet metal strip, wherein these collars are embodied in such a way that they engage in one another over the length of the liquid channel when sheet metal parts having these collars are stacked on top of one another.

### TECHNICAL FIELD

The invention relates to a method for producing at least one liquid channel in a laminated core, more particularly for an electric machine, and a laminated core produced thereby, in which method multiple openings are produced in a piece of sheet metal or sheet metal strip, multiple sheet metal parts are subsequently separated from the piece of sheet metal or sheet metal strip, which sheet metal parts each have at least one opening of said openings, and the sheet metal parts are stacked on top of one another in such a way that the openings define at least the liquid channel extending in the laminated core.

### PRIOR ART

To cool a laminated core of a stator of an electric machine, namely a generator, it is known (EP2109206A1, DE29707181U1) to provide an axial liquid channel in the laminated core of the stator, which channel is defined by openings in sheet metal parts of the laminated core.

To accomplish this—for example by using a lamination stacking process—these sheet metal parts are stamped out of a piece of sheet metal or sheet metal strip into which openings for the liquid channel have previously been punched. After the sheet metal parts are stacked on top of one another, they are laminated to form the laminated core, thus producing an axial liquid channel in the laminated core. The lamination can also, as disclosed in DE29707181U1, be performed by means of gluing.

Coolant flows through the liquid channel and problems of leakage in the liquid channel, for example due to lamination defects, are countered by using an electrically insulating coolant.

This does prevent electrical short-circuits—but escaped coolant disadvantageously increases the rotational resistance in the electric machine, which in turn reduces its efficiency.

### SUMMARY OF THE INVENTION

The object of the invention, therefore, is to modify a method of the type described at the beginning in such a way that produces a liquid-tight liquid channel in the laminated core in a reproducible way. The method should also be easy to implement and enable an economical production of laminated cores that is efficient in terms of time.

If a collar is produced on each of at least two openings in that these collars are formed into the piece of sheet metal or sheet metal strip and/or sheet metal part or if at least two openings each having a collar are produced in the piece of sheet metal or sheet metal strip in that these collars are formed into the piece of sheet metal or sheet metal strip, this can offer the possibility of embodying the liquid channel as media-tight if these collars are embodied in such a way that they engage in one another over the length of the liquid channel when sheet metal parts having these collars are stacked on top of one another.

Specifically, the collars that engage with one another can define the edge of the liquid channel in overlapping fashion, which can seal the liquid channel in a reproducible way.

This is true even if a piece of sheet metal or sheet metal strip is provided with a hot-melt adhesive varnish in order to thus provide a sufficient seal between the stacked sheet metal parts in the region of the liquid channel. More particularly, this hot-melt adhesive varnish is thermosetting and more particularly is embodied in the form of backlack—which makes the method for laminating the sheet metal parts into a laminated core particularly reproducible.

In addition, the method for producing a collar can be carried out with method steps of the same type, by means of which the openings are produced in the piece of sheet metal or sheet metal strip or in the sheet metal part, so that the method can remain easy to implement, efficient in terms of time, and economical. This can be advantageous if the laminated core produced in this way is for an electric machine such as an electric motor or electric generator.

By contrast with the prior art, the method according to the invention can therefore feature a significantly higher processing speed.

The media-tightness of the liquid channel can be further improved if the collars each have a conical section. More particularly, the conical section adjoins the sheet plane of the piece of sheet metal or sheet metal strip or sheet metal part that has this collar.

Preferably, the conical section has a first width in the range from 0.2 to 2 times the thickness of the piece of sheet metal or sheet metal strip in order to be able to produce an even better seal of the liquid channel.

A first width of more than 0.2 times the thickness of the piece of sheet metal or sheet metal strip can further improve the tightness mainly due to the overlapping of the relevant sheet metal parts. This advantage is further enhanced by increasing the first width even more. But an overlap of more than 2 times the thickness of the piece of sheet metal or sheet metal strip can adversely affect the magnetic properties in this region—in addition, there is also the risk of material defects such as cracks, which could adversely affect the reproducibility of the method.

Preferably, the collars are embodied as frustoconical in cross-section in their conical section—which can further simplify the method for producing these collars.

Preferably, the collars each have a flat section extending offset from and parallel to the sheet plane in order to thus be able to establish an overlap between the collars regardless of the sheet thickness. Preferably, the flat section adjoins the conical section. Preferably, the flat section defines the opening.

For example, the flat section has a second width in the range from 0.2 to 1.5 times the thickness of the piece of sheet metal or sheet metal strip. If the second width is more than 0.2 times the thickness of the piece of sheet metal or sheet metal strip, this can further improve the reproducibility of the method. Specifically, the flat section can, for example, reduce a negative influence of dimensional tolerances in the sheet thickness on the overlapping area between the sheet metal parts in the region of the collar. By contrast, a second width of more than 1.5 times the thickness of the piece of sheet metal or sheet metal strip can complicate the geometry in the laminated core or also a possible connection to a cooling system.

The liquid channel can be produced in an easy-to-implement way over the total length of the laminated core if, apart from the first sheet metal part in the laminated core, all of the sheet metal parts that are stacked after this first sheet metal part have collars on their openings for the liquid channel.

Preferably, the liquid channel extends in the axial direction of the laminated core in order to ensure a precisely fitting mutual engagement of the collars and to thus reproducibly achieve a media-tight liquid channel. Preferably, the liquid channel extends off-center relative to the laminated core, preferably passing all the way through this laminated core.

The method for producing the laminated core can be simplified if the collars in the piece of sheet metal or sheet metal strip and/or into the sheet metal part are produced by pressing, which makes it possible to produce identically embodied collars economically and with reproducible dimensions. This pressing can take place, for example, by means of an embossing procedure.

A particularly media-tight liquid channel can be manufactured in a reproducible way if collars are produced with a collar height in the range from greater than or equal to 0.5 times to less than 2 times—more particularly 1 times—the thickness of the piece of sheet metal or sheet metal strip. Preferably, collars are produced with a collar height in the range from greater than or equal to 0.5 times to less than 1 times the thickness of the piece of sheet metal or sheet metal strip.

The implementation of the method can be further simplified if the openings are punched into the piece of sheet metal or sheet metal strip.

The method can be further simplified if the sheet metal parts that have the hot-melt adhesive varnish between them are glued to one another upon and/or after being stacked on top of one another. This is more particularly true if the hot-melt adhesive varnish is thermosetting, more particularly is a backlack.

Preferably, the hot-melt adhesive varnish is activated when the sheet metal parts are stacked—which can further increase the process speed in the production of a laminated core with a liquid channel. For example, with a thermosetting hot-melt adhesive varnish, this activation takes place when the hot-melt adhesive varnish is heated to its curing temperature.

This above-mentioned advantage can be enhanced even further if the sheet metal parts are stacked in a stack brake of a progressive stamping tool.

Another object of the invention is to improve a laminated core with a liquid channel in terms of tightness relative to a liquid and thus to prevent leakage.

If the collars on openings of the sheet metal parts in the laminated core engage with one another in sequence over the length of the liquid channel, then this can yield a liquid channel in the laminated core that is particularly media-tight in terms of leakage.

It can turn out to be particularly advantageous for a leak-tight liquid channel if the collars each have a conical section and/or each have a flat section that extends offset from and parallel to the sheet plane.

Preferably and more particularly, the flat section extending offset from and parallel to the sheet plane adjoins the conical section of the respective collar.

### BRIEF DESCRIPTION OF THE DRAWINGS

The subject of the invention is shown in greater detail in the figures with the aid of one embodiment by way of example. In the drawings:

FIG. 1 shows a schematic view of a device for producing laminated cores with a liquid channel,

FIG. 2 shows an enlarged partial view of the liquid channel of a laminated core, and

FIG. 3 shows an enlarged view of a collar of a sheet metal part of the laminated core from FIG. 2.

### DETAILED DESCRIPTION OF THE INVENTION

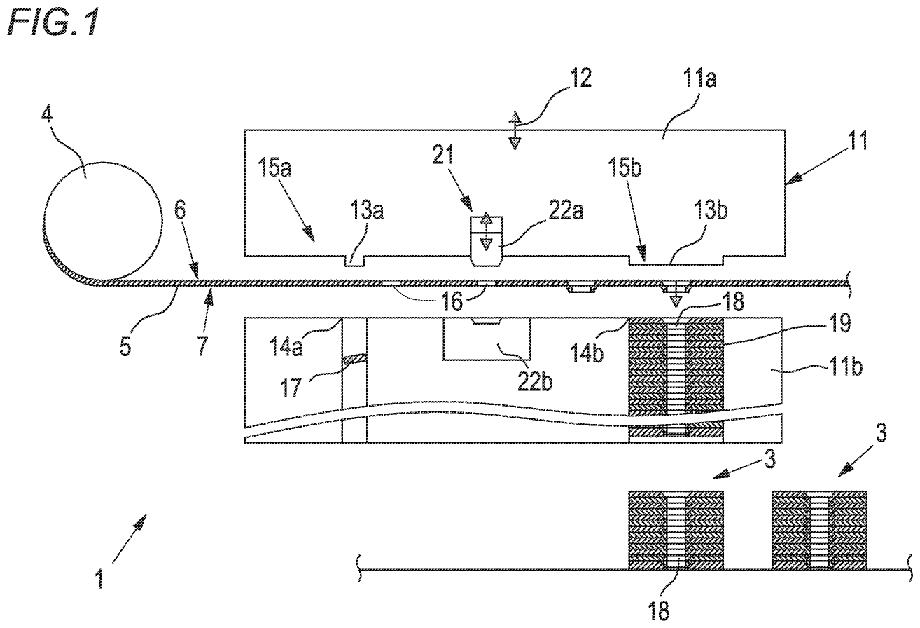

FIG. 1 schematically depicts an exemplary embodiment of a device 1 for carrying out the method according to the invention. This device 1 is used for stacking stamped-out sheet metal parts 2a, 2b into laminated cores 3. This method therefore constitutes a lamination stacking process. The laminated core 3 produced in this way can be used, for example, in an electric machine.

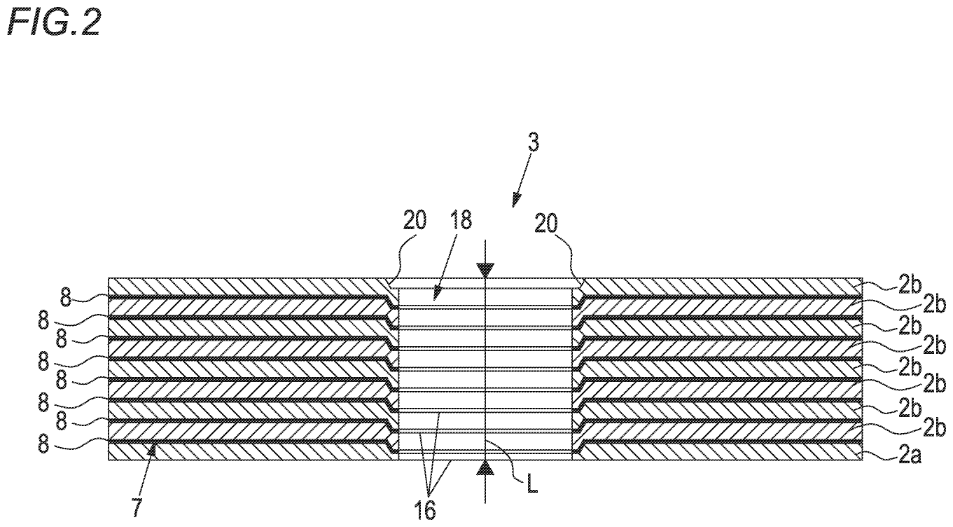

For this purpose, a sheet metal strip 5, namely composed of electrical strip (or of an electrical sheet in the case of a piece of sheet metal), which is completely covered with an adhesive layer 8, namely a heat-hardening hot-melt adhesive layer such as backlack, on one flat side 6 of the two flat sides 6, 7, is unwound from a coil 4. These adhesive layers 8 are shown in FIG. 2.

This electrical strip/electrical sheet, which is typically composed of an iron-silicon alloy, is manufactured for example in the form of non-grain-oriented sheets or grain-oriented sheets. Because of their isotropic magnetic properties, non-grain-oriented electrical sheets are mainly used in rotating machines such as electric motors.

It should be noted in general that such a thermally activatable and thus heat-hardening hot-melt adhesive varnish layer 8, 9 or hot-melt adhesive layer is also known by the term “backlack”. For example, the hot-melt adhesive varnish can be epoxy resin-based. Preferably, the hot-melt adhesive varnish is a bisphenol-based epoxy resin system with a hardener, for example a dicyandiamide-based hardener. More particularly, the above-mentioned hot-melt adhesive varnish can be a bisphenol-A-epichlorohydrin resin system with dicyanamide as a hardener. This two-stage hardening epoxy resin system is in the B state on the sheet metal strip 5. The partially cross-linked hot-melt adhesive varnish is therefore reactive. When heat is supplied, the hot-melt adhesive varnish in the B state reacts further and can thus be brought into the fully cross-linked C state—which is also referred to as baking. Typically, this partially cross-linked hot-melt adhesive varnish layer 8, 9 has a thickness of a few micrometers. The sheet metal strip 5 has a strip thickness d of 0.3 mm (millimeters).

Multiple sheet metal parts 2a, 2b are separated, namely stamped out from, the adhesive-coated sheet metal strip 5 with the aid of a stamping tool 11—a progressive stamping tool in the exemplary embodiment. It should in general be noted that such a stamping-out can be a cutting-out, cutting-off, detaching, trimming, breaking up by popping out, etc.

As can also be inferred from FIG. 1, the stamping tool 11 carries out a cutting with multiple strokes 12. To accomplish this, the blades 13a, 13b in the upper tool 11a of the stamping tool 11 cooperate with the respective dies 14a, 14b of the lower tool 11b of the stamping tool 11 and thus constitute two stamping stages 15a, 15b in the stamping tool 10.

With the first blade 13a of the upper tool 11a, an opening 16 is produced in the sheet metal strip 5, namely is stamped out from it, which is evident from the stamped-out remainder 17 in FIG. 1. With the second blade 13b, the sheet metal part 2a or 2b is separated from the sheet metal strip 5.

The opening 16 is provided in the sheet metal strip 5 for each separated sheet metal part 2a, 2b since in the laminated core 3, this opening 16 defines a liquid channel 18 that passes axially through—more particularly all the way through—the laminated core 3, which is more clearly visible in FIG. 2.

Then with the aid of the stamping stage 15b, the sheet metal parts 2a, 2b are stamped out and, through the pressing of the upper tool 11a, are pushed into a stacking device 19 and stacked therein. The stacking device 19 has a guide in the lower tool 11b for this purpose. A counter-support 10, not shown, is also provided in the guide.

The stacking device 19 is actively heated in order to activate the thermosetting hot-melt adhesive varnish 8 and produce an adhesive bond or integral bond between the sheet metal parts 2 by means of baking. This laminates the sheet metal part 2a, 2b to the laminated core 3.

In order to produce a liquid channel 18 that is media-tight in terms of leakage, on each of the openings 16 that have already been produced in the sheet metal strip 5 of the sheet metal parts 2b, a respective collar 20 is produced by means of embossing with a punch 22a and a die 22b in the forming stage 21. The respective first sheet metal part 2a of a laminated core 3 does not have such a collar 20. The collars 20 of the sheet metal parts 2b are embodied in such a way that they engage in one another over the length L of the liquid channel 18 when sheet metal parts 2b having these collars 20 are stacked on top of one another. This produces a particularly tight connection of the sheet metal parts 2b—and thus ensures the liquid channel 18 against leakage of liquid.

The collars 20 can also, however, be produced at the same time as the openings 16 in the sheet metal strip 5, but this is not shown in detail. It is also conceivable for the collars 20 to be formed not into the sheet metal strip 5 but into the relevant sheet metal parts 2b, which is also not shown in detail.

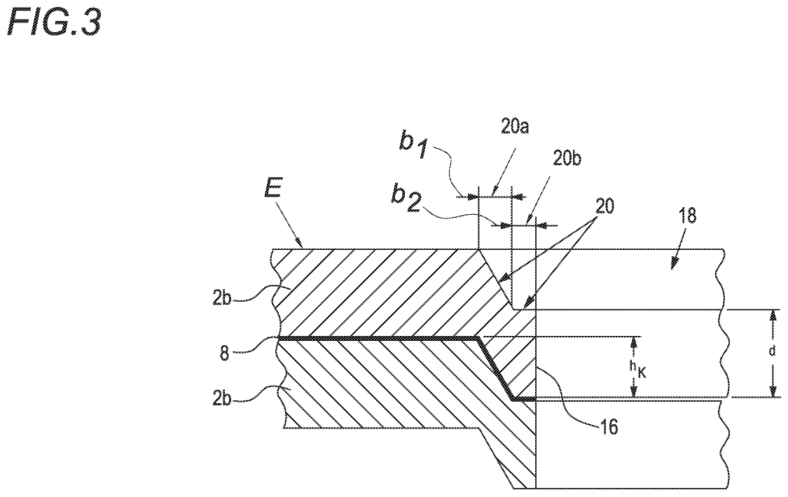

As is apparent in FIG. 3, the collars 20 each have a conical section 20a and adjoining the latter, a flat section 20b, which ends at the opening 16.

The conical section 20a has a first width b1 of 0.10 mm (millimeter), which seals the liquid channel particularly well against leakage. The adjoining flat section 20b has a second width b2 of 0.075 mm (millimeter), which makes it as easy as possible to manufacture.

The flat section 20b is offset from and parallel to the sheet plane E of the piece of sheet metal or sheet metal strip or the relevant sheet metal part 2a, 2b that has this collar 20—as can be seen in FIG. 3. In addition, the flat section 20b defines the opening 16. This reproducibly provides a particularly media-tight liquid channel 18 through the laminated core 3.

As is also apparent in FIG. 3, the conical section 20b is embodied as frustoconical in cross-section.

In addition, the collar height hₖ is 0.2 mm (millimeter), which is less than the thickness d and greater than half the thickness d of the sheet metal strip 5 or the sheet metal part 2b that is cut off from the strip. This produces a particularly stable collar 20 for a rugged media-tight connection between the sheet metal parts 2b.

Preferably, the thickness d of the piece of sheet metal or sheet metal strip is from 0.1 mm (millimeter) to 0.35 mm, preferably from 0.2 mm to 0.3 mm.

It should be noted in general that the German expression “insbesondere” can be translated as “more particularly” in English. A feature that is preceded by “more particularly” is to be considered an optional feature, which can be omitted and does not thereby constitute a limitation, for example, of the claims. The same is true for the German expression “vorzugsweise”, which is translated as “preferably” in English.

1. A method for producing at least one liquid channel in a laminated core, comprising:
providing a piece of sheet metal or sheet metal strip with a hot-melt adhesive varnish,
producing a plurality of openings in the piece of sheet metal or sheet metal strip,
separating a plurality of sheet metal parts from the piece of sheet metal or sheet metal strip, each of the plurality of sheet metal parts having at least one opening of the plurality of openings, and
producing a collar on each of at least two of the plurality of openings, wherein each of the collars is formed into at least one of the group consisting of: the piece of sheet metal, the sheet metal strip, and at least one of the plurality of sheet metal parts, and
stacking the plurality of sheet metal parts on top of one another in such a way that the plurality of openings define the at least one liquid channel extending in the laminated core, and
wherein each of the collars engage in one another over a length of the liquid channel when sheet metal parts having the collars are stacked on top of one another.

2. The method according to claim 1, wherein the collars each have a conical section.

3. The method according to claim 2, wherein in the conical section of each collar, the collars are frustoconical in cross-section and/or the conical section has a first width in the a range of 0.2 to 2 times a thickness of the piece of sheet metal or sheet metal strip.

4. The method according to claim 2, wherein the collars each have a flat section extending offset from and parallel to a sheet plane of the sheet metal or sheet metal strip.

5. The method according to claim 4, wherein the flat section extending offset from and parallel to the sheet plane adjoins the conical section and/or the flat section extending offset from and parallel to the sheet plane has a second width in a range from 0.2 to 1.5 times the thickness of the piece of sheet metal or sheet metal strip.

6. The method according to claim 1, wherein, apart from a first sheet metal part in the laminated core, all subsequent sheet metal parts that are stacked after the first sheet metal part have the collars on their openings for the liquid channel.

7. The method according to claim 1, wherein the liquid channel extends in an axial direction of the laminated core.

8. The method according claim 1, wherein the collars are pressed into the piece of sheet metal or sheet metal strip and/or into the plurality of sheet metal parts.

9. The method according to claim 1, wherein the collars are produced with a collar height in a range from greater than or equal to 0.5 times to less than 2 times the a thickness of the piece of sheet metal or sheet metal strip.

10. The method according to claim 1, comprising stamping the plurality of openings into the piece of sheet metal or sheet metal strip.

11. The method according to claim 1, comprising providing the piece of sheet metal or sheet metal strip with a thermosetting hot-melt adhesive varnish.

12. The method according to claim 11, wherein the plurality of sheet metal parts that have the hot-melt adhesive varnish between the plurality of sheet metal parts are glued to one another upon and/or after being stacked on top of one another.

13. The method according to claim 12, wherein the hot-melt adhesive varnish is activated when the plurality of sheet metal parts are stacked.

14. The method according to claim 1, comprising stacking the plurality of sheet metal parts in a stack brake of a progressive stamping tool.

15. A laminated core produced by the method according to claim 1, wherein the collars on the plurality of openings of the sheet metal parts engage in one another in sequence over the length of the liquid channel.

16. The laminated core according to claim 15, wherein the collars each have a conical section and/or the collars each have a flat section extending offset from and parallel to a sheet plane of the sheet metal or sheet metal strip.

17. The laminated core according to claim 16, wherein the flat section extending offset from and parallel to the sheet plane adjoins the conical section.
